(19) United States
(12) Patent Application Publication
(10) Pub. No.: US 2015/0088936 A1
(43) Pub. Date: Mar. 26, 2015

(54) Statistical Analysis using a graphics processing unit

(71) Applicants: Lei Wang, Beijing (CN); Min Wang, Cortlandt Manor, NY (US); Liu Keyan, Beijing (CN); Shimin Chen, Beijing (CN); Xing-Xing Ju, Beijing (CN)

(72) Inventors: Lei Wang, Beijing (CN); Min Wang, Cortlandt Manor, NY (US); Liu Keyan, Beijing (CN); Shimin Chen, Beijing (CN); Xing-Xing Ju, Beijing (CN)

(21) Appl. No.: 14/396,650

(22) PCT Filed: Apr. 23, 2012
(86) PCT No.: PCT/CN2012/074509

§ 371 Date: Oct. 23, 2014

(51) Int. Cl. G06F 17/30

(52) U.S. Cl. CPC G06F 17/30289; G06F 17/30324
USPC 707/802

(57) ABSTRACT

A data structure having plural elements may be divided into plural sections, each section including a portion of the plural elements. The data structure may include information related statistical analysis. Instructions may be generated to execute a function on the data structure on a section-by-section basis. These instructions may be executed by a graphics processing unit.

### BACKGROUND

Large-scale or massive-scale statistical analysis, sometimes referred to as MaSSA, may involve examining large amounts of data at once. For example, scientific instruments used in astronomy, physics, remote sensing, oceanography, and biology can produce large data volumes. Efficiently processing such large amounts of data may be challenging.

### BRIEF DESCRIPTION OF THE DRAWINGS

Some embodiments are described with respect to the following figures:

FIG. 1 is a schematic diagram of a system according to example implementations.

FIG. 2 is a schematic workflow diagram of a system in according to example implementations.

FIG. 3 is a schematic diagram of data structures according to example implementations.

FIG. 4 is a flow diagram depicting a technique for executing instructions on a GPU according to example implementations.

FIG. 5 is a flow diagram depicting a technique for using a GPU to perform statistical analysis according to example implementations.

### DETAILED DESCRIPTION

Traditional database systems may encounter certain difficulties when processing data for large-scale statistical analyses. Current database systems may approach storage of data at an element granularity. For instance, a data structure such as a matrix may be stored in an array, and each data element in the matrix may correspond to an element in the array. Dense arrays having many elements (e.g., arrays representing large matrices) can occupy a large amount of storage space, and in some cases may be larger than available memory.

Furthermore, database query engines use an iterative execution model to execute functions on the stored data on an element-by-element basis. As such, iterating through each element in a data structure to satisfy a complicated query request may be relatively inefficient. In the context of large data sets, the inefficiency in executing such query requests may be exacerbated, thereby degrading performance of the database system.

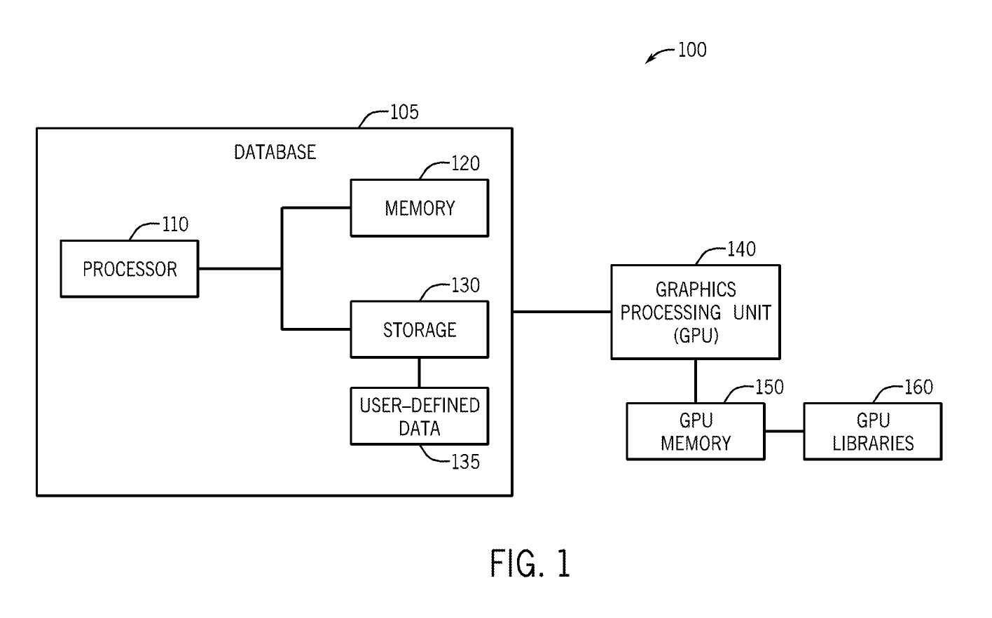

FIG. 1 is a schematic diagram of an example system 100 in accordance with some implementations. The database subsystem 105 of the system 100 may include a processor 110, a memory 120, and a storage 130 in communication with each other. The storage 130 may store user-defined data 135, which is described in more detail below. In some implementations, the user-defined data 135 may also be stored in memory 120. Although reference is made to a database subsystem in some implementations, it is noted that techniques or mechanisms described herein can also be used in other systems.

The database subsystem 105 may also be in communication with a graphics processing unit (GPU) 140. The GPU 140 may be coupled to a GPU memory 150 which may store GPU libraries 160. The GPU 140 may be a graphics processing unit that is capable of executing particular computations traditionally performed by a central process unit (CPU) such as the processor 110. This ability may be referred to as general purpose computing in graphics processing unit (GPGPU). Such capabilities may be in addition to the ability of the GPU 140 to perform computations for computer graphics, which provide images for display in a display device (not shown).

The GPU libraries 160 may provide an interface for the database subsystem 105 to access the GPU 140 to execute the particular computations traditionally performed by a CPU (e.g. processor 110). Indeed, the GPU libraries 160 may provide access to instructions sets for the GPU 140 as well as the GPU memory 150. For example, through the GPU libraries 160, a developer may be able to use a standard programming language (such as C) to code instructions for execution on the GPU 140 to take advantage of the GPU's 140 parallel processing architecture.

In some implementations, the GPU 140 may have multiple processing cores with each core capable of processing multiple threads simultaneously. The GPU 140 may have relatively high parallel processing capability, which may benefit operations on large data sets such as those produced by large-scale statistical analyses. Certain processing cores within the GPU 140 may have relatively high floating-point computational capabilities, which may be appropriate in large-scale statistical analysis. Other processing cores may have relatively low floating-point computation abilities and may be used only for processing graphics data. For example, algebraic operations performed on matrices (e.g., matrix multiplication, transposition, addition, etc.) may be conducive to a parallel processing architecture and floating-point computational power provided by the GPU 140.

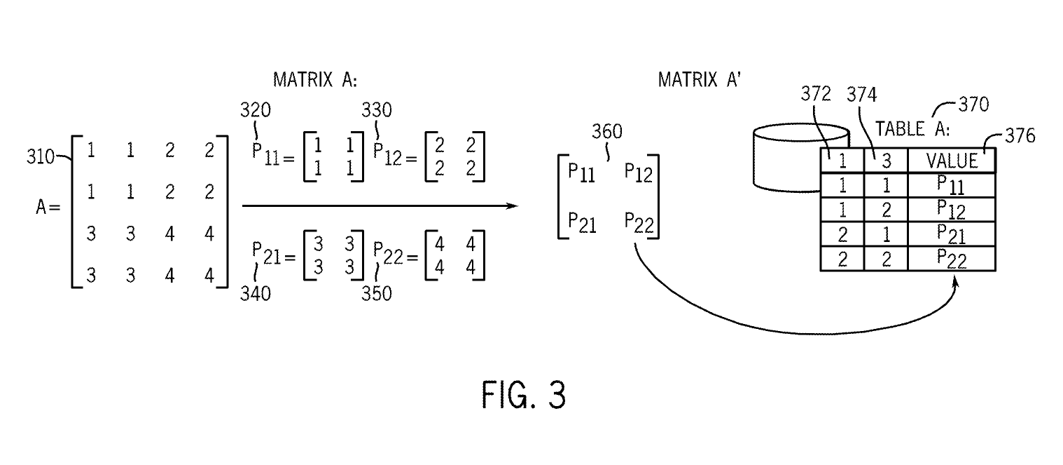

In some implementations, the user-defined data 135 may include instructions for dividing a data structure into multiple sections and storing these sections as data elements in a table or array. Such a table is described in more detail with respect to FIG. 3. Additionally, the user-defined data 135 may also include user-defined functions to perform operations on the data structure on a section-by-section basis rather than on an element-by-element basis. To perform the operation, a user-defined function may invoke the GPU libraries 160 to instruct the GPU 140 to execute the function.

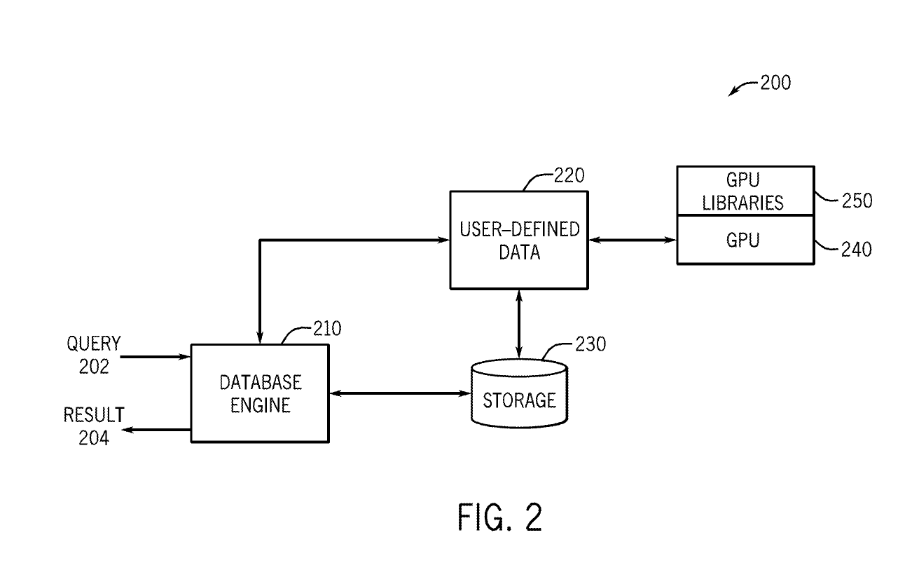

FIG. 2 provides a schematic workflow diagram of a database system 200 according to some implementations. The database system 200 may include a database engine 210 to receive a query 202 and to return a result 204 for the query 202. In some implementations, the database engine 210 may include similar components to the database subsystem 105 of FIG. 1 such as the processor 110 and the memory 120.

As shown in FIG. 2, the database engine 210 may access user-defined data 220 (similar to user-defined data 135 in FIG. 1) in response to receiving a query 202. The user-defined data 220 may include user defined functions that operate on data elements stored in storage 230. Furthermore, these data elements may be contained within large data structures used in large-scale statistical analysis. As such, the GPU libraries 250 in the GPU 240 may be called or invoked to execute the user-defined functions to take advantage of the parallel processing capabilities of the GPU 240.

In some instances, the database engine 210 may be implemented using PostgreSQL, which provides for an open source object-relational database management system (ORDBMS). PostgreSQL may provide a framework for developers to extend the ORDBMS through the use of various user-defined definitions. For example, User-Defined Types (UDTs) may enable developers to create unique data structures within PostgreSQL. Similarly, User-Defined Functions (UDFs) may enable the creation of functions that operate on the UDTs. User-Defined Aggregates (UDAs) may be a type of UDF that performs a calculation on a set of values and returns a single value. Thus, rather than creating an entirely new programming language to manage the numerous data in large-scale data analyses, an existing database framework such as PostgreSQL can simply be extended to provide the desired functionality through the use of UDTs, UDFs, and UDAs.

For example, a UDT data structure may be created for storing a matrix as a collection of sub-matrices rather than a collection of individual data elements in the matrix. Various UDFs and UDAs may be created that can operate on the above created UDT data structure. For example, a developer can create a UDF that performs matrix multiplication on the UDT data structure, i.e., at the sub-matrix granularity instead of at a data element granularity. This level of abstraction may enable reduced input/output (I/O) operations in the database system 200 when compared to functions that operate on an element by element basis.

In some implementations, the GPU libraries 250 may be according to the Compute Unified Device Architecture (CUDA), Open Computing Language (OpenCL), or a combination thereof. OpenCL may provide a standard for writing programs that can be executed across heterogeneous platforms including CPUs, GPUs, and other types of processors. Thus, a program written under OpenCL may generate instructions that can be executed by both the processor 110 and the GPU 140. CUDA may be a parallel computing architecture developed by NVIDIA Corp. to specifically manage NVIDIA GPUs. Using CUDA, developers may use the ‘C’ programming language to call functions in the CUDA library to execute instructions on an NVIDIA GPU. Thus, in some examples, the GPU 140 may be an NVIDIA GPU that is associated with CUDA libraries.

FIG. 3 is a schematic diagram depicting a data structure in accordance with some implementations. In some instances, the data structure may be a matrix such as Matrix A 310. For example, Matrix A 310 may be a 4×4 matrix having 16 data elements and may be divided into four sections P₁₁ 320, P₁₂ 330, P₂₁, 340 and P₂₂ 350. P₁₁ 320 may represent the top left section of Matrix A 310, P₁₂ 330 may represent the top right section, P₂₁ 340 may represent the bottom left section, and P₂₂ 350 may represent the bottom right section. Thus, each section may be a 2×2 sub-matrix of Matrix A 310. In some implementations, the sections may be referred to as “chunks.”

After dividing Matrix A 310 into these four sections, Matrix A can then be represented by Matrix A′ 360, which may include each section 320-350 or sub-matrix as data elements. Matrix A′ 360 can then be stored into an array, such as Table A 370, which can be recognized by a computer or other processing device. In some instances, Table A 350 may be defined using a UDT in PostgreSQL to specifically store Matrix A 310 as a collection of its sections 320-250, rather than a collection of its individual elements, in Table A 350.

Furthermore, in some implementations, Matrix A 310 may be stored in a memory (e.g., memory 120 and/or GPU memory 150 in FIG. 1) in column major form. Column major form may provide a technique for linearizing a multi-dimensional matrix or other data structure into a one-dimensional data structure or device such as memory 120/150, which may store data serially. For example, consider the matrix

$$[ \begin{matrix}1 & 2 & 3 \\ 4 & 5 & 6\end{matrix} ] .$$

In column major form, this matrix may be stored in a one-dimensional array as {1, 4, 2, 5, 3, 6}. Moreover, storing data in column major form may be suitable to facilitate certain GPU calculation techniques. However, other storage methods are also possible, such as row-major, Z-order, and the like.

As previously mentioned, certain UDFs and UDAs may also be created to operate on a UDT data structure such as Table A 370. In some implementations, Table A 370 may conceptualize Matrix A 310 into two rows and two columns. Thus, index I 372 of Table A 370 may represent the rows of Matrix A 310 while index J 374 may represent the columns of Matrix A 310. The Value 376 may correspond to the sub-matrix 320-350 represented by each combination of index I 372 and index J 374. For example, sub-matrix P₂₁ 340 is the Value 376 corresponding to when index I=2 and index J=1.

For a UDT data structure, section-oriented aggregation operators may be created to function similarly to certain SQL functions such as SUM, COUNT, MIN, and MAX, which traditionally operate at the data element granularity. For instance, a new function such as CHUNK_SUM( )may replace SUM( ) while MATRIX MULTIPLY( )may replace the standard operator * to operate on a UDT data structure on a section-by-section basis. The naming of these new functions are merely examples and any other names are also contemplated. While FIG. 3 is described with reference to a matrix data structure, it should be noted that other types of data structures are also possible.

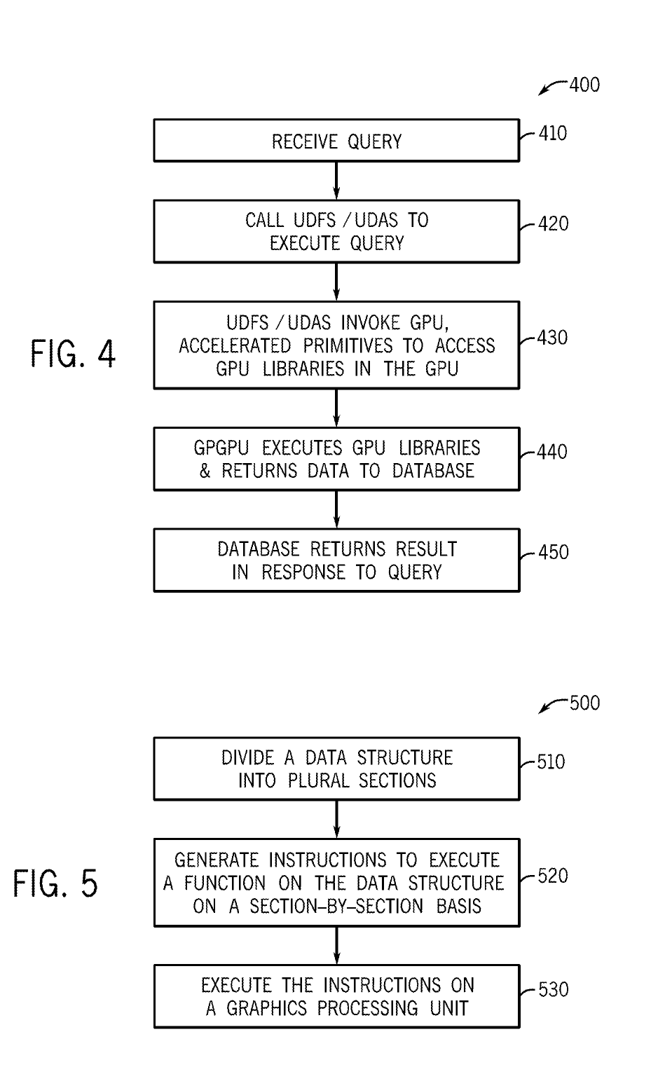

FIG. 4 is a flow diagram depicting a method 400 for using a GPU in a system in accordance with some implementations. The method may begin in block 410, where a query is received such as by the database engine 210 of FIG. 2. In some implementations, the query may relate to accessing data regarding large-scale data analyses. As such, various user-defined data 220 (e.g., the UDT Table A 370 and various UDFs and UDAs to operate on the UDT Table A 370) may be called to execute the query in block 420.

In order to increase efficiency in execution, the UDFs/UDAs may invoke GPU libraries 250 to access the GPU 240 in block 430. In particular, the UDFs/UDAs may invoke certain GPU-accelerated primitives, which in turn access GPU libraries 250. For example, a UDF such as MATRIX MULTIPLY( )may be recognizable by the database engine 210 for performing matrix multiplication between two matrices. MATRIX MULTIPLY( )may then call various GPU-accelerated primitives to actually invoke GPU libraries 250 for performing matrix multiplication between sub-matrices of the two matrices. Since the GPU 240 may be capable of a relatively high degree of parallel processing, the GPU 240 may be efficient in executing functions on relatively large amounts of data related to large-scale statistical analyses, which can include matrix multiplication and other mathematical tasks.

Then, in block 440, the GPU 240 may execute the GPU libraries 250 invoked by the particular UDFs/UDAs. For example, data may be copied from a main memory of the database engine 210 (e.g. memory 120) into GPU memory (e.g., GPU memory 150). A processor (e.g., processor 110) in the database engine 210 may then instruct the GPU 240 to process the data by executing these GPU libraries 250. Subsequently, the GPU 240 may then return the results of the execution from GPU memory 150 to main memory 120 in the database engine 210. Finally, in block 450, the database engine 250 may return the results to a user in response to the query received in block 410.

FIG. 5 is a flow diagram depicting a method 500 in accordance with some implementations. The method may begin in block 510 where a data structure is divided into plural sections. The data structure may have plural elements, and each section of the data structure may include a portion of the plural elements. Moreover, the data elements of the data structure may be related to large-scale statistical analyses. In some implementations, the data structure may be a matrix stored as a user-defined table (e.g., Table A 370). Thus, each of the sections may represent a sub-matrix, and the user-defined table may store each of these sub-matrices as data elements.

In block 520, the method 500 may generate instructions to execute a function on the data structure on a section-by-section basis. This may be in contrast executing the function on an element by element basis. In some examples, where the data structure may be matrix, the function may be an algebraic operation, such as matrix multiplication, transposition, etc. Thus, instead of iterating through each element of the matrix, the function may iterate through on a section-by-section basis, thereby increasing input/output efficiency and performance.

In block 530, the instructions from the function may be executed on a graphics processing unit (GPU). In some implementations, the GPU may be a GPGPU capable of executing instructions normally executed by a CPU.

Instructions of modules described above (including modules for performing tasks of FIG. 4 or FIG. 5) are loaded for execution on a processor (such as one or more processors 110 in FIG. 1). A processor can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method, comprising:
dividing a data structure into plural sections, the data structure having plural elements, wherein each section comprises a portion of the plural elements, and wherein the data structure contains information related to statistical analysis;
generating instructions to execute a function on the data structure on a section-by-section basis; and
executing the instructions on a graphics processing unit (GPU).

2. The method of claim 1, wherein the data structure includes a matrix.

3. The method of claim 2 further comprising storing the matrix into a table, wherein a particular row in the table corresponds to a particular section of the matrix.

4. The method of claim 3 further comprising storing the matrix in column-major form in a memory associated with the GPU.

5. The method of claim 1, wherein the function comprises algebraic matrix operations.

6. The method of claim 5, wherein the function is created by a user to extend a database programming language.

7. The method of claim 6, wherein the database programming language is PostgreSQL.

8. The method of claim 1, wherein executing the instructions comprises invoking GPU libraries associated with the GPU.

9. A system, comprising:
a processor;
a graphics processing unit (GPU); and
a storage to store instructions, which when executed by the processor, cause the processor to:
divide a data structure into plural sections, the data structure having plural elements, wherein each section comprises a portion of the plural elements, and wherein the data structure contains information related to statistical analysis;
generate particular instructions to execute a function on the data structure on a section-by-section basis; and
instruct the GPU to execute the particular instructions.

10. The system of claim 9, wherein the data structure includes a matrix.

11. The system of claim 10, wherein the instructions further cause the processor to store the matrix into a table, wherein a particular row in the table corresponds to a particular section of the matrix.

12. The system of claim 11, wherein the instructions further cause the processor to store the matrix in column-major form in the memory.

13. The system of claim 9, wherein the function comprises algebraic matrix operations.

14. The system of claim 13, wherein the function is created by a user to extend a database programming language.

15. The system of claim 9, wherein the database programming language is PostgreSQL.

16. The system of claim 15, wherein the data structure is a User-Defined Type (UDT) in PostgreSQL.

17. A non-transitory computer readable medium to store instructions that, when executed by a processor, cause the processor to:
divide a data structure into plural sections, the data structure having plural elements, wherein each section comprises a portion of the plural elements, and wherein the data structure contains information related to statistical analysis;
generate particular instructions to execute a function on the data structure on a section-by-section basis; and
copy the data structure to a memory associated with a graphics processing unit (GPU), wherein the GPU is to execute the particular instructions on the data structure.

18. The computer readable medium of claim 17, wherein the data structure includes a matrix.

19. The computer readable medium of claim 18, wherein the instructions further cause the processor to store the matrix into a table, wherein a particular row in the table corresponds to a particular section of the matrix.

20. The computer readable medium of claim 19, wherein the instructions further cause the processor to store the matrix in column-major form in the memory.
